(19) United States
(12) Patent Application Publication
(10) Pub. No.: US 2010/0230201 A1
(43) Pub. Date: Sep. 16, 2010

(54) THREE-WHEEL FORKLIFT TRUCK

(76) Inventor: Martin McVicar, County Monaghan (IE)

Correspondence Address: VAN DYKE, GARDNER, LINN & BURKHART, LLP, SUITE 207, 2851 CHARLEVOIX DRIVE, S.E., GRAND RAPIDS, MI, 49546, US

(21) Appl. No.: 12/601,338

(22) PCT Filed: May 23, 2008
(86) PCT No.: PCT/EP2008/004140

§ 371 Date: Nov. 23, 2009

(30) Foreign Application Priority Data
May 24, 2007 (IE) S2007/0379

(51) Int. Cl. B60K 17/14

(52) U.S. Cl. 180/308

(57) ABSTRACT

A forklift truck comprises two driven front wheels 12L, 12R and a single driven central rear wheel 14. The truck is operable in a sideways mode (FIGS. 2A-2C) in which the rear wheel is fixed at an angle substantially parallel to an axis passing through the two front wheels and the two front wheels are steered in synchronism in opposite directions of rotation. The truck is further operable in a rotational mode in which the center of rotation C of the truck is disposed inside a notional circle 200 passing through all three wheels. The truck enters the rotational mode from the sideways mode by automatic reversal of the drive direction of the rear wheel, by actuating a changeover valve 40, when the center of rotation moves from outside to inside the notional circle.

This invention relates to a three-wheel forklift truck.

### SUMMARY OF THE INVENTION

The invention provides a forklift truck comprising a chassis having two driven, steerable front wheels and a single driven rear wheel disposed centrally between, but displaced rearwardly of, the front wheels, wherein the truck is operable in a sideways mode in which the rear wheel is fixed at an angle substantially parallel to an axis passing through the two front wheels and the two front wheels are steered in synchronism in opposite directions of rotation, and wherein the truck is operable in a rotational mode in which the center of rotation of the truck is disposed inside a notional circle passing through all three wheels, the truck entering the rotational mode from the sideways mode by automatic reversal of the drive direction of the rear wheel when the center of rotation moves from outside to inside the notional circle.

These and other objects, advantages and features of this invention will become apparent upon review of the following specification in conjunction with the drawings.

### BRIEF DESCRIPTION OF THE DRAWINGS

An embodiment of the invention will now be described, by way of example, with reference to the accompanying drawings, in which:

FIGS. 1A-1C are schematic plan views of a forklift truck according to a first embodiment of the invention, operating in standard mode;

FIGS. 2A-2C are schematic plan views of the truck of FIGS. 1A-1C operating in sideways mode; and

FIGS. 3A-3C are schematic plan views of the truck of FIGS. 1A-1C operating in rotational mode.

### DESCRIPTION OF THE PREFERRED EMBODIMENT

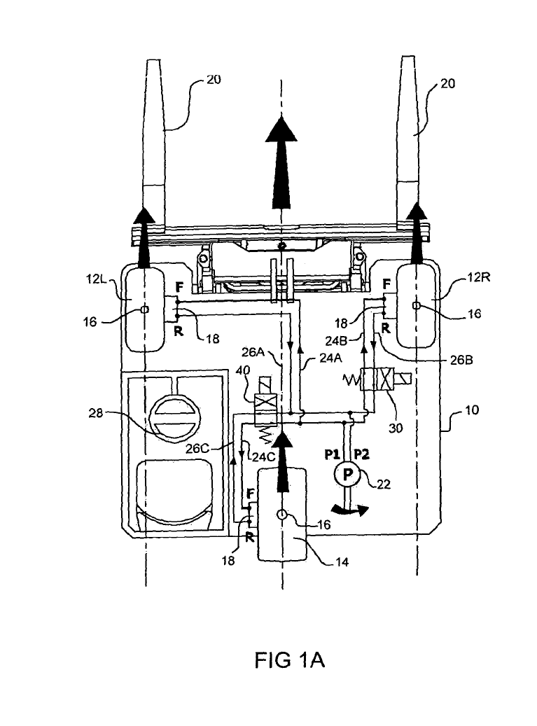

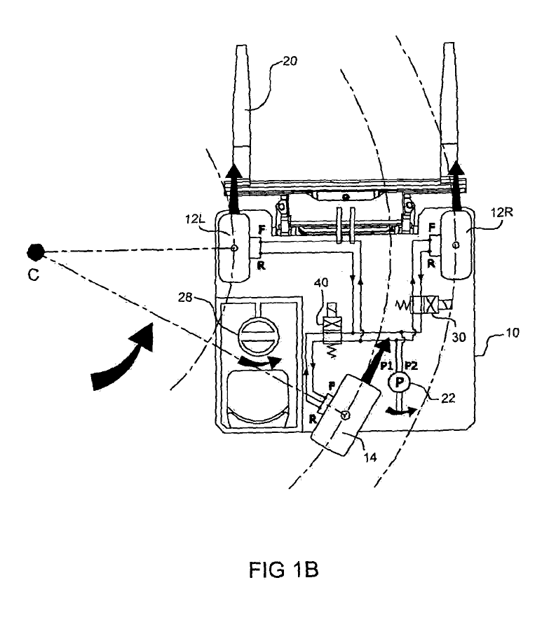

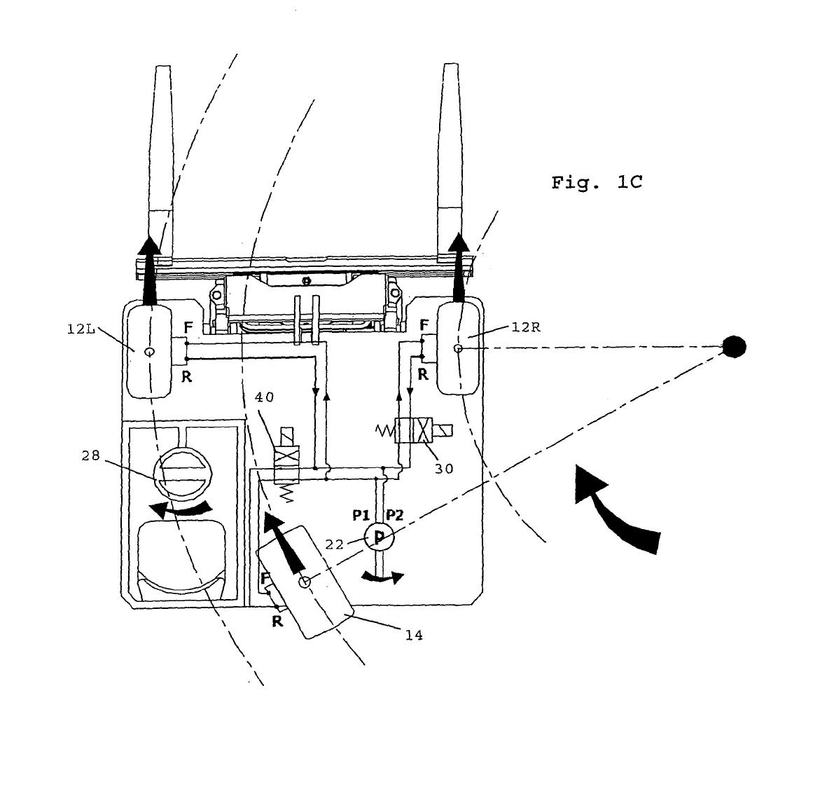

Referring to FIG. 1A, a three-wheel, four-directional forklift truck with all-wheel drive comprises a chassis 10 having left and right front ground wheels 12L, 12R, respectively, and a single rear ground wheel 14 disposed centrally between, but rearwardly displaced, relative to the front wheels. All three wheels are steerable by rotation about respective substantially vertical axes 16. Such rotation is effected by a respective hydraulic cylinder associated with each wheel, the actuation/deactuation of the hydraulic cylinders being controlled by the truck driver using a steering wheel 28. This is well-known and is, therefore, not shown. The chassis carries a conventional mast (not shown) and lift forks 20.

Each wheel 12L, 12R and 14 can be driven selectively in either one of two opposite directions of rotation by a respective hydrostatic motor 18. Each motor has hydraulic fluid inlet ports F and R, respectively, the application of hydraulic fluid under pressure to the inlet port F driving the wheel in a forward direction (indicated by the arrows in FIG. 1A) and the application of hydraulic fluid under pressure to the inlet port R driving the wheel in the reverse direction. The motors 18 are driven by a hydraulic circuit which includes a pump 22 for supplying hydraulic fluid under pressure selectively to fluid supply ports P1 and P2, respectively, the supply ports being connected to the motors 18 by hydraulic lines 24A, 24B, 24C, 26A, 26B and 26C.

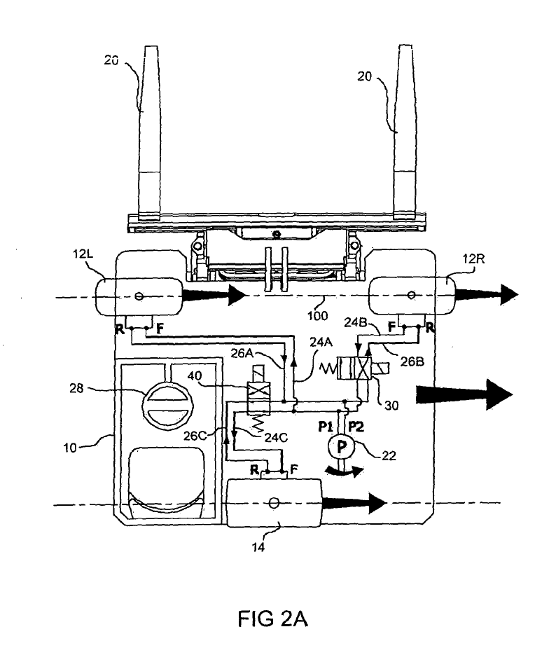

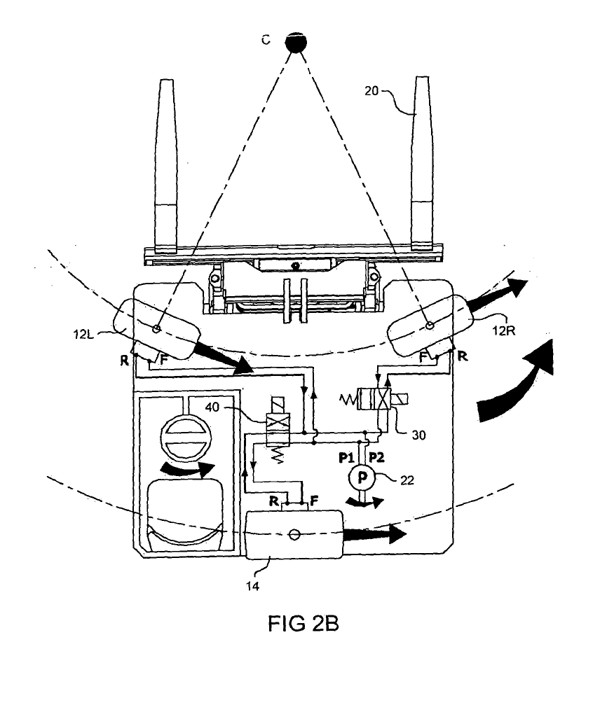

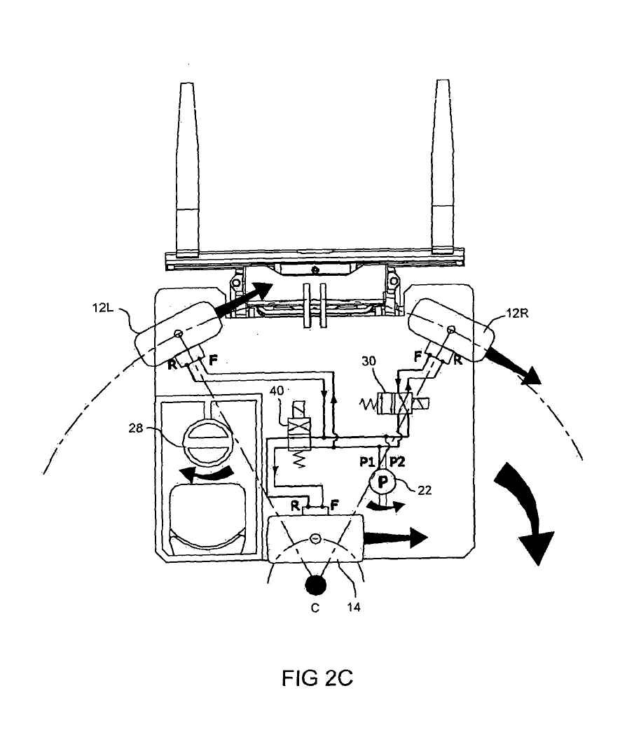

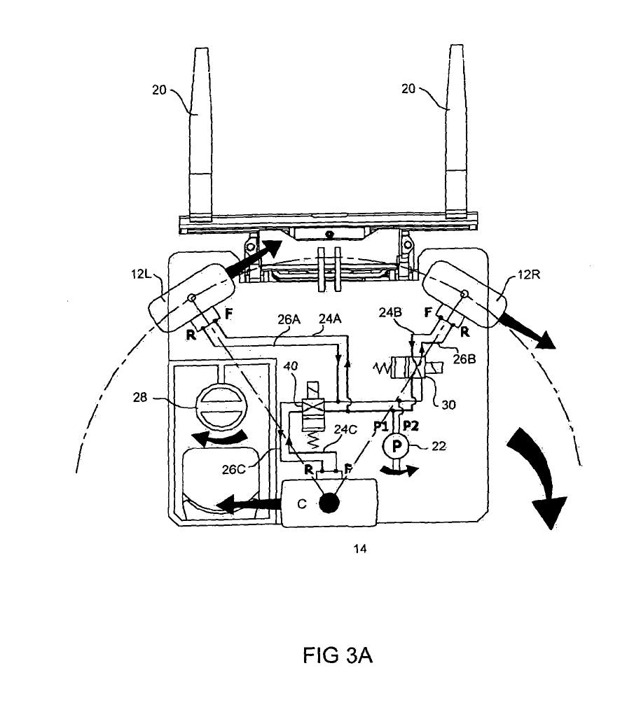

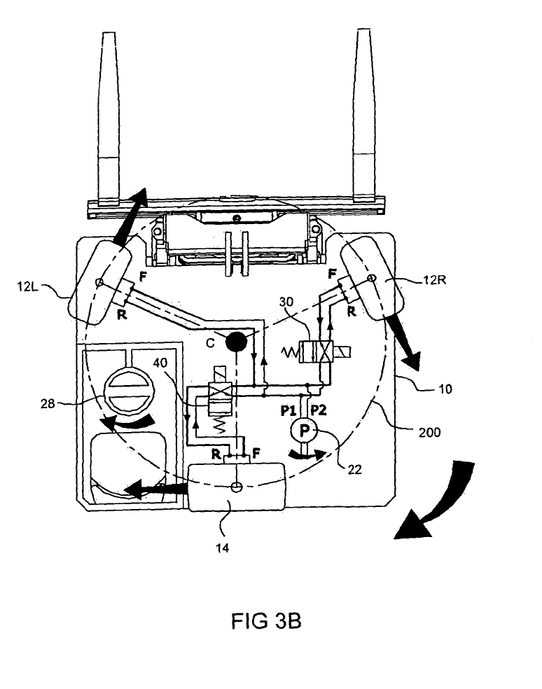

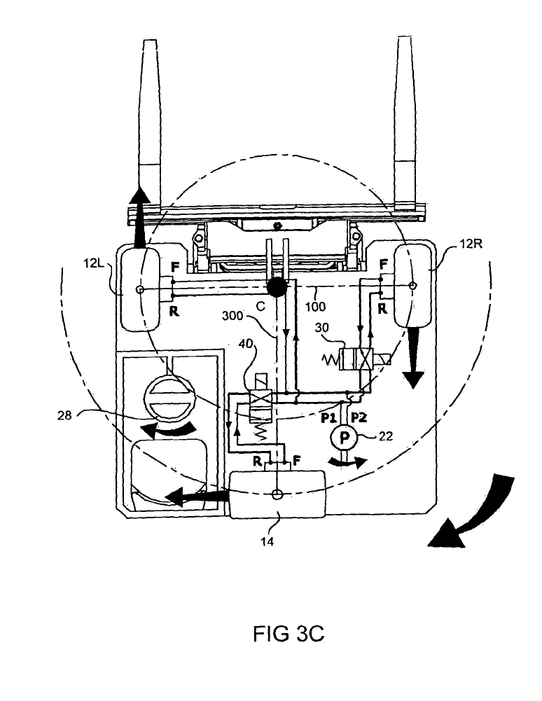

The inlet ports F, R of the right front wheel 12R are coupled to the supply ports P1, P2 of the pump 22 via a selectively actuable switchover valve 30. Similarly, the inlet ports F, R of the rear wheel 14 are coupled to the supply ports P1, P2 of the pump 22 via a selectively actuable switchover valve 40. The inlet ports F, R of the other front wheel 12L is non-switchably coupled to the supply ports P1, P2, respectively. The operation of the valve 30 is such that when the valve is not actuated (as shown in FIGS. 1A-1C) the inlet ports F, R of the right front wheel 12R are connected to the supply ports P1, P2, respectively, whereas when the valve is actuated (FIGS. 2A-2C and 3A-3C) the hydraulic lines 24B, 26B cross over so that the inlet ports F, R of the wheel 12R are connected to the supply ports P2 , P1, respectively. Similarly, the operation of the valve 40 is such that when the valve is not actuated (as shown in FIGS. 1A-1C), the inlet ports F, R of the rear wheel 14 are connected to the supply ports P1, P2, respectively, whereas, when the valve is actuated (FIGS. 3A-3C), the hydraulic lines 24C, 26C cross over so that the inlet ports F, R of the wheel 14 are connected to the supply ports P2, P1, respectively. The valves 30 and 40 can be actuated and de-actuated hydraulically, mechanically, electro-magnetically or in any other suitable manner.

When the truck is configured for standard (i.e., forward/reverse) operation, FIGS. 1A-1C, the valves 30 and 40 are not actuated. In order to drive the truck in the forward direction, fluid under pressure is supplied by the pump 22 to the supply port P1 and thus to the hydraulic lines 24A, 24B and 24C. Therefore, the fluid pressure is applied to the inlet port F of each wheel motor IS, and all three wheels are driven in a forward direction. In order to drive the truck in the reverse direction (not shown), the fluid under pressure supplied by the pump 22 is simply switched from the supply port P1 to the supply port P2 and is thus removed from the inlet ports F and applied to the inlet ports R via the hydraulic lines 26A, 26B and 26C. The switchover of the hydraulic fluid under pressure between the supply ports P1 and P2 is effected under operator control. In standard mode, in both forward and reverse drive directions, the front wheels 12L, 12R of the truck are turned parallel to one another in the front-to-rear direction and locked in that position, and the rear wheel 14 is steered by the operator in a conventional manner to steer the vehicle, i.e., the rear wheel is rotated clockwise (FIG. 1B) or anti-clockwise (FIG. 1C) about its axis 16 as the steering wheel 28 is rotated one way or the other. In the drawings, the dash-dotted arcs are the paths of travel of the wheels of the truck and, when the truck is not moving in a straight line, the point C is the center of rotation of the truck.

In order to configure the truck for operation in sideways mode, FIGS. 2A-2C, the rear wheel 14 is turned parallel to an axis 100 (FIG. 2A) passing through the two front wheels and locked in that position, and the front wheels are turned inwards (i.e., in plan view the wheel 12L is rotated clockwise about its axis 16 and the wheel 12R anti-clockwise about its axis 16), each through 90°, so that they lie in line and parallel with the rear wheel (i.e., substantially normal to the front-to-rear direction of the chassis). Also, the valve 30 is actuated so that the hydraulic lines 24B, 26B cross over whereby the inlet ports F, R of the wheel 12R are connected to the supply ports P2, P1, respectively. These actions may be effected automatically by the vehicle control system (not shown) when the operator selects sideways mode, for example, by pressing a button located in the cab.

Now, if the hydraulic fluid under pressure is supplied to the port P1, all three wheels, and, hence, the truck, will drive to the right, as indicated by the arrows in FIG. 2A. Alternatively, if the hydraulic fluid under pressure is supplied to the port P2, all three wheels will drive to the left (not shown). In sideways mode, in both left and right drive directions, the front wheels 12L, 12R of the truck can be steered by the operator, to change the directional course of the truck. When steering in sideways mode, both front wheels rotate in synchronism in opposite directions, i.e., when one rotates clockwise about its axis 16 the other rotates anti-clockwise about its axis 16, and vice versa (FIGS. 2B and 2C).

The truck is also operable in a rotational mode (FIGS. 3A-3C) in which the center of rotation C of the truck is within a notional circle 200 (FIG. 3B) passing through all three wheels. The truck can be made to enter the rotational mode automatically from sideways mode by the operator turning the steering wheel 28 to rotate the front wheels 12L, 12R sufficiently to bring the center of rotation C within the notional circle 200. At the point at which the center of rotation C moves from outside to inside the notional circle 200, FIG. 3A, the switchover valve 40 is automatically actuated to reverse the drive direction of the rear wheel 14 (compare FIGS. 2C and 3A). Correspondingly, the switchover valve 40 is automatically actuated when the center of rotation C moves from inside to outside the notional circle 200, when reverting to sideways mode from rotational mode, to restore forward drive to the rear wheel 14. The point at which the center of rotation C moves inside the notional circle 200 can be detected by, for example, a sensor attached to one of the front wheels. The sensor can be a proximity switch, a hydraulic switch or any other suitable mechanism for determining when the wheel has turned to a predetermined angle.

In rotational mode, like sideways mode, steering is as for sideways mode, i.e., both front wheels rotate in synchronism in opposite directions. The center of rotation C can be anywhere along a line 300 (FIG. 3C) extending from the rear wheel to a point midway along the axis 100.

Then, if it is desired to rotate the truck in a clockwise direction about the axis C, FIG. 3A, hydraulic fluid under pressure is supplied to the port P1. This fluid pressure is applied via the lines 24A, 24B and 24C to the inlet port F of each wheel so that the wheels are driven in the directions indicated by the arrows.

If the truck enters rotational mode from sideways mode when the truck is moving left to right, the truck will rotate clockwise in rotational mode, as shown in FIGS. 3A-3C. However, if the truck enters rotational mode from sideways mode when the truck is moving right to left, the truck will rotate anti-clockwise in rotational mode.

The advantage of the above arrangement is that the truck enters rotational mode from sideways mode automatically by continuing to rotate the steering wheel 28 in the same direction. Other alternatives would work depending on the steering direction of the wheels, the side of the wheel the drive motors are mounted on, and even just coupling the switchover valve to the left front wheel instead of the right front wheel.

The invention is applicable to a three-wheel forklift truck driven by one or two hydrostatic motors, or indeed by other drive means.

The invention is not limited to the embodiment described herein and may be modified or varied without departing from the scope of the invention.

1. A forklift truck, comprising:
a chassis having two driven, steerable front wheels and a single driven rear wheel disposed centrally between, but displaced rearwardly of, the front wheels, wherein the truck is operable in a sideways mode in which the rear wheel is fixed at an angle substantially parallel to an axis passing through the two front wheels and the two front wheels are steered in synchronism in opposite directions of rotation, and wherein the truck is operable in a rotational mode in which the center of rotation of the truck is disposed inside a notional circle passing through all three wheels, the truck entering the rotational mode from the sideways mode by automatic reversal of the drive direction of the rear wheel when the center of rotation moves from outside to inside the notional circle.

2. A forklift truck as claimed in claim 1, wherein each wheel motor is a hydrostatic motor, the truck further including a hydraulic circuit for supplying hydraulic fluid under pressure to each motor.

3. A forklift truck as claimed in claim 2, wherein each motor has first and second hydraulic fluid inlet ports, the application of hydraulic fluid under pressure to the first inlet port driving the wheel in one direction and the application of hydraulic fluid under pressure to the second inlet port driving the wheel in the opposite direction, and wherein the hydraulic circuit comprises a source of hydraulic fluid under pressure having first and second fluid supply ports, the hydraulic fluid under pressure being selectively supplied at the first or second supply port.

4. A forklift truck as claimed in claim 3, wherein the first and second inlet ports of the rear wheel are coupled to the first and second supply ports via a selectively actuable switchover valve, wherein when the truck is operated in sideways mode the switchover valve is not actuated, and wherein when the truck enters rotational mode the switchover valve is automatically actuated.

5. A forklift truck as claimed in claim 4, wherein the rear wheel is also steerable and the truck is operable in a standard mode in which the two front wheels are fixed substantially parallel to one another in the front-to-rear direction of the chassis and the rear wheel is steered, and wherein the first and second inlet ports of one of the front wheels are coupled to the first and second supply ports via a further selectively actuable switchover valve, the further switchover valve not being actuated in the standard mode but being actuated in the sideways and rotational modes.
